(19) United States
(12) Patent Application Publication
(10) Pub. No.: US 2009/0073683 A1
(43) Pub. Date: Mar. 19, 2009

(54) Light Guide Plate and Direct-Type Surface Light Source Device

(76) Inventors: Chien-Hsiang Chen, Hsinchu Industrial Park (TW); Ming-Dah Liu, Hsinchu Industrial Park (TW)

Correspondence Address: HDLS Patent & Trademark Services, P.O. BOX 220746, CHANTILLY, VA, 20153-0746, US

(21) Appl. No.: 12/142,776

(22) Filed: Jun. 20, 2008

(30) Foreign Application Priority Data
Sep. 17, 2007 (TW) 096134726

(51) Int. Cl. F21S 4/00

(52) U.S. Cl. 362/224

(57) ABSTRACT

A light guide plate includes a plurality of light guide units each including a light exit surface, a bottom surface, a first side surface and a second side surface. The first and the second side surfaces respectively include a first oblique surface and a second oblique surface. The first and the second oblique surfaces are opposite to each other and both adjoining the bottom surface. The first side surface of one of the each two adjacent light guide units is joined with the second side surface of the other one and thereby the light exit surfaces of the light guide units cooperatively form a substantially flat surface. The light guide units define a plurality of receiving cavities spaced apart from one another by the first and the second oblique surfaces thereof. In addition, a direct-type surface light source device using the light guide plate also is provided.

### BACKGROUND

1. Technical Field

The present invention generally relates to a light guide plate and a direct-type surface light source device and, particularly, to a light guide plate in any size with a high light utilization efficiency and a direct-type surface light source device using the same.

2. Description of the Related Art

Liquid crystal displays (LCDs) are primarily employed in various information, communication and consume products, such as personal computers, liquid crystal televisions, mobile phones, videophones, personal digital assistants and so on. Because a LCD panel is non-emissive, a backlight module is necessarily required for providing an uniform and high brightness surface light source to achieve a good visual effect. A direct-type surface light source device is one type of backlight module and generally is applied to large-sized liquid crystal displays.

The direct-type surface light source device generally includes a light guide plate and a plurality of point light sources or a plurality of linear light sources. The light guide plate is configured to convert light emitted from the point light sources or the linear light sources into a surface light source, in order to provide a surface light illumination to a LCD panel. Because a size of the direct-type surface light source device is necessarily to match with that of the LCD panel, when the size of the LCD panel is increased, the size of the direct-type surface light source device is correspondingly needed to increase along therewith. However, since the size of the light guide plate is fixed, it is necessary to redesign different sized light guide plate in order to match a different sized LCD panel. In other words, single design of the light guide plate could not match the LCD panels with different sizes and thus the applicability of the light guide plate is narrow in some degree. In addition, a large sized LCD panel generally has a relatively high requirement at the aspect of light output uniformity and brightness of the direct-type surface light source device, which requires the direct-type surface light source device to have a characteristic of high light utilization efficiency.

### BRIEF SUMMARY

A light guide plate in accordance with a present embodiment is provided. The light guide plate includes a plurality of light guide units. Each of the light guide units includes a light exit surface, a bottom surface opposite to the light exit surface, a first side surface connecting the light exit surface and the bottom surface and a second side surface opposite to the first side surface. The first side surface includes a first oblique surface and the second side surface includes a second oblique surface. The first oblique surface and the second oblique surface are opposite to each other and both adjoining with the bottom surface. The first side surface of one of the each two adjacent light guide units is joined with the second side surface of the other one and thereby the light exit surfaces of the light guide units cooperatively form a substantially flat surface. The light guide units define a plurality of receiving cavities by the first oblique surfaces and the second oblique surfaces, and the receiving cavities are spaced apart from one another.

A direct-type surface light source device in accordance with another present embodiment is provided. The direct-type surface light source device includes a light guide plate, a reflective plate and a plurality of light sources. The light guide plate includes a plurality of light guide units. Each of the light guide units includes a light exit surface, a bottom surface opposite to the light exit surface, a first side surface connecting the light exit surface and bottom surface and a second side surface opposite to the first side surface. The first side surface includes a first oblique surface and the second side surface includes a second oblique surface. The first oblique surface and the second oblique surface are opposite to each other and both adjoining the bottom surface. The first side surface of one of the each two adjacent light guide units is joined with the second side surface of the other one and thereby the light exit surfaces of the light guide units cooperatively form a substantially flat surface. The light guide units define a plurality of receiving cavities by the first oblique surfaces and second oblique surfaces, and the receiving cavities are spaced apart from one another. The reflective plate is disposed on the bottom surfaces of the light guide units. The light sources are corresponding to the light guide units and disposed between the light exit surfaces of the light guide units and the reflective plate, the light sources are spaced apart from one another. In one embodiment, the light sources are disposed in the receiving cavities respectively. In another embodiment, each of the light guide units has a receiving groove defined in the bottom surface, the receiving groove extending along the lengthwise direction of the light guide unit and penetrating through the light guide unit along the lengthwise direction, and the light sources are disposed in the receiving grooves of the light guide units respectively.

Since the light guide plate is formed by a plurality of light guide units joined with one another, the light guide plate can be configured with any size by changing the amount of the light guide units and thus the direct-type surface light source device using the same can match any sized liquid crystal display panel. Furthermore, the structural configuration of the first and second side surfaces between the light exit surface and the bottom surface for each of the light guide units allows light beams emitted from the light sources to be effectively directed/guided toward the substantially flat surface for output, and thereby high light utilization efficiency may be achieved. In addition, the bottom surfaces of the light guide units are surface shaped structure, which can improve the assembly convenience of the light guide plate when being applied to the direct-type surface light source device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic structural view of a direct-type surface light source device in accordance with a first embodiment of the present invention.

FIG. 2 is a schematic, exploded view of the direct-type surface light source device of FIG. 1.

FIG. 3 is a schematic, side view of the direct-type surface light source device of FIG. 1.

FIG. 4 shows optical paths of the direct-type surface light source device of FIG. 1.

FIG. 5 is a schematic, side view of a direct-type surface light source device in accordance with a second embodiment of the present invention.

FIG. 6 is a schematic, side view of a direct-type surface light source device in accordance with a third embodiment of the present invention.

FIG. 7 is a schematic, side view of a direct-type surface light source device in accordance with a fourth embodiment of the present invention.

FIG. 8 shows optical paths of the direct-type surface light source device of FIG. 7.

FIG. 9 is a schematic, side view of a direct-type surface light source device in accordance with a fifth embodiment of the present invention.

FIG. 10 shows optical paths of the direct-type surface light source device of FIG. 9.

### DETAILED DESCRIPTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component faces “B” component directly or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

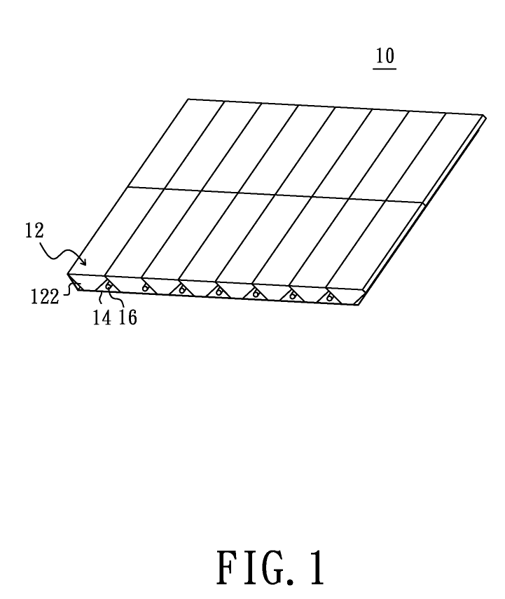

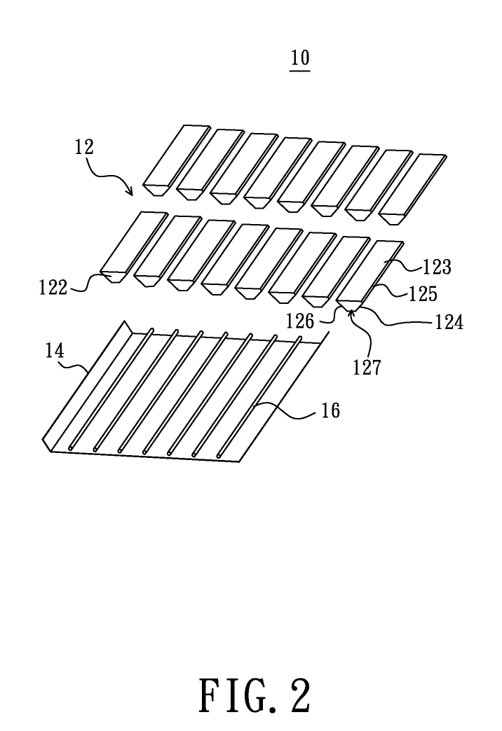

Referring to FIGS. 1 through 3, a direct-type surface light source device 10 in accordance with a first embodiment of the present invention is provided. The direct-type surface light source device 10 includes a light guide plate 12, a reflective plate 14 and a plurality of light sources 16.

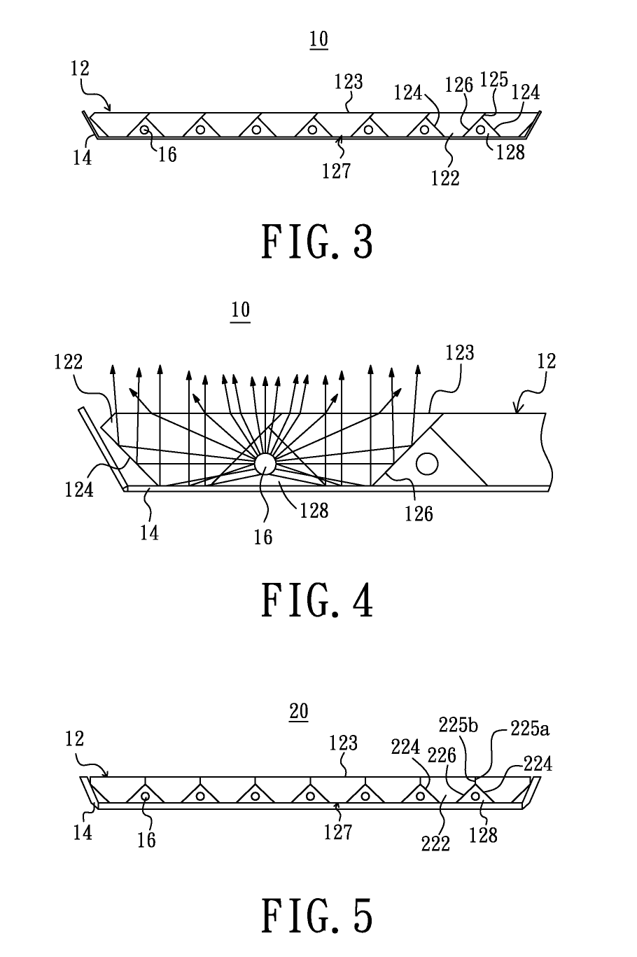

The light guide plate 12 includes a plurality of light guide units 122 having an identical size and joined with one another. FIG. 1 illustrates sixteen light guide units 122, which is merely for the purpose of illustration but not limitation, the sixteen light guide units 122 are prismatic structures with an identical size. Each of the light guide units 122 includes a light exit surface 123, a bottom surface 127, a first side surface connecting the light exit surface 123 and the bottom surface 127, and a second side surface opposite to the first side surface. The first side surface includes a first oblique surface 124 and a joint surface 125, the second side surface includes a second oblique surface 126. The first oblique surface 124 and the second oblique surface 126 are opposite to each other and both adjoining the bottom surface 127. The bottom surface 127 is a surface shaped structure. The first oblique surface 124 and the second oblique surface 126 both are substantially flat surfaces. The joint surface 125 is located between and connects the first oblique surface 124 and the light exit surface 123. Advantageously, an angle between the first oblique surface 124 and the bottom surface 127 is same as that between the second oblique surface 126 and the bottom surface 127. The first side surface of one of each two adjacent light guide units 122 is joined with the second side surface of the other one of each two adjacent light guide units 122 and thereby the light exit surfaces 123 of the light guide units 122 cooperatively form a substantially flat surface as the light output surface of the light guide plate 12. In the present embodiment, each two adjacent light guide units are joined with each other by the joint surface 125 of the first side surface of one of the two adjacent light guide units 122 joining with the second side surface of the other one via a surface contact manner. The employment of the surface contact manner facilitates the light guide plate 12 to achieve a high structural stability. The first oblique surface 124 of each of the light guide units 122 and the second oblique surface 126 of a neighboring light guide unit 122 cooperatively define a receiving cavity 128. The defined receiving cavities 128 of the light guide plate 12 are spaced apart from one another and each of the receiving cavities 128 has an identical cross-section, e.g., V-shaped cross-section as illustrated in FIG. 3.

The reflective plate 14 is disposed on the bottom surfaces 127 of the light guide units 122. In particular, the reflective plate 14 is surface-contacted with the bottom surfaces 127 of the light guide units 122, the light guide units 122 are disposed on the reflective surface 14.

The light sources 16 are corresponding to the light guide units 122 and disposed between the light exit surfaces 123 of the light guide units 122 and the reflective plate 14. More specifically, the light sources 16 are respectively disposed in the receiving cavities 128 spaced apart from one another. As seen from FIGS. 1 through 3, the light sources 16 are spaced apart from one another. The light sources 16 each is a linear light source, such as a cold cathode fluorescent lamp or a linear array of point light source (e.g., light emitting diode).

Referring to FIG. 4, showing optical paths of the direct-type surface light source device 10. As seen from FIG. 4, light rays emitted from each of the light sources 16 and incident from the two light guide units 122 which are adjacent to the light source 16 to air are, due to the configuration of the first oblique surface 124 and the second oblique surface 126 of the two light guide units 122, primarily directed by the first and the second oblique surfaces 124, 126 where a total reflection phenomenon occurs toward the light exit surfaces 123 for output. As a result, the utilization efficiency of the light rays emitted from each of the light sources 16 is greatly improved.

Referring to FIG. 5, a direct-type surface light source device 20 in accordance with a second embodiment of the present invention is provided. The direct-type surface light source device 20 has a structural configuration similar to that of the direct-type surface light source device 10 in accordance with the first embodiment and includes a light guide plate 12, a reflective plate 14 and a plurality of light sources 16. However, the light guide plate 12 of the direct-type surface light source device 20 includes a plurality of light guide units 222, a first side surface of each of the light guide units 222 includes a first oblique surface 224 and a joint surface 225a, a second side surface of each of the light guide units 222 includes a second oblique surface 226 and a joint surface 225b. The first oblique surface 224 and the second oblique surface 226 are opposite to each other and both adjoining the bottom surface 127. The joint surface 225a is located between and connects the first oblique surface 224 and the light exit surface 123. The joint surface 225b is located between and connects the second oblique surface 226 and the light exit surface 123. The joint surface 225a of one of each two adjacent light guide units 222 is surface-contacted with the joint surface 225b of the other one.

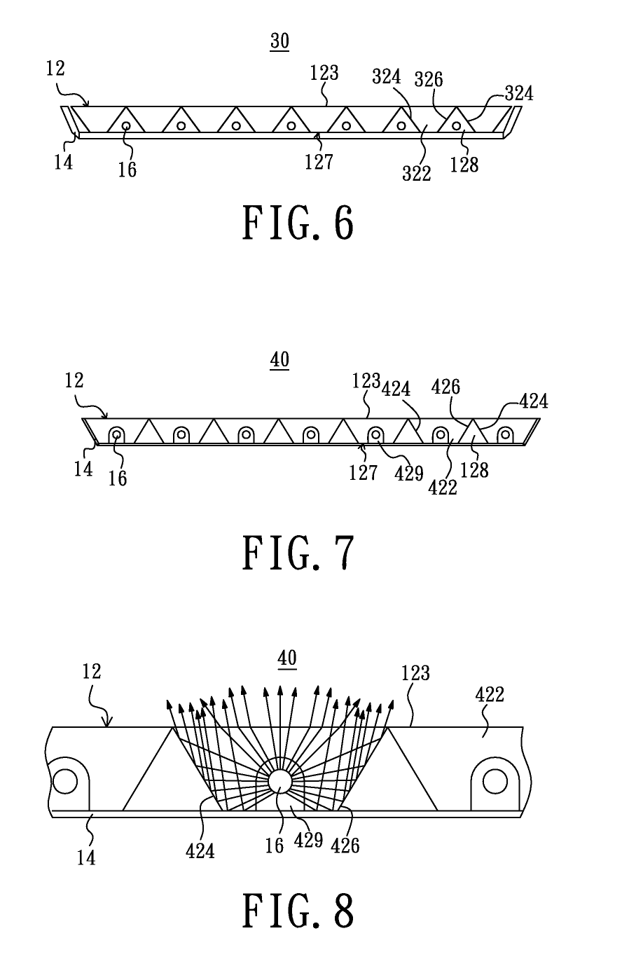

Referring to FIG. 6, a direct-type surface light source device 30 in accordance with a third embodiment of the present invention is provided. The direct-type surface light source device 30 has a structural configuration similar to that of the direct-type surface light source device 10 in accordance with the first embodiment and includes a light guide plate 12, a reflective plate 14 and a plurality of light sources 16. However, the light guide plate 12 of the direct-type surface light source device 30 includes a plurality of light guide units 322, a first side surface and a second side surface of each of the light guide units 322 respectively includes a first oblique surface 324 and a second oblique surface 326 and both are not configured with any joint surface. The first side surface of one of each two adjacent light guide units 322 is line-contacted with the second side surface of the other one.

Referring to FIGS. 7 and 8, a direct-type surface light source device 40 in accordance with a fourth embodiment of the present invention is provided. The direct-type surface light source device 40 has a structural configuration similar to that of the direct-type surface light source device 10 in accordance with the first embodiment and includes a light guide plate 12, a reflective plate 14 and a plurality of light sources 16. However, the light guide plate 12 of the direct-type surface light source device 40 includes a plurality of light guide units 422, a first side surface and a second side surface of each of the light guide units 422 respectively includes a first oblique surface 424 and a second oblique surface 426 and both are not configured with any joint surface. The first side surface of one of the each two adjacent light guide units 422 is line-contacted with the second side surface of the other one. Furthermore, each of the light guide units 422 has a receiving groove, e.g., arc-shaped groove 429 defined in the bottom surface 127 thereof. The arc-shaped groove 429 extends along the lengthwise direction of the light guide unit 422 and penetrates through the light guide unit 422 along the lengthwise direction. The light sources 16 are respectively disposed in the arc-shaped grooves 429 of the light guide units 422 instead, rather than disposed in the receiving cavities 128 as illustrated in the direct-type surface light source device 10 in accordance with the first embodiment.

Referring to FIG. 8, showing optical paths of the direct-type surface light source device 40. As seen from FIG. 8, because the light sources 16 are disposed in the arc-shaped receiving grooves 429 of the light guide units 422, light rays emitted from each of the light sources 16 directly enter into the light guide unit 422 which has the arc-shaped receiving groove 429 where the light source 16 is disposed. Due to the configuration of the first oblique surface 424 and the second oblique surface 426, light rays incident from the light guide unit 422 to air are primarily directed by the first and second oblique surfaces 424, 426 where a total reflection phenomenon occurs toward the light exit surface 123 for output. Consequently, the utilization efficiency of the light rays emitted from each of the light sources 16 is greatly improved.

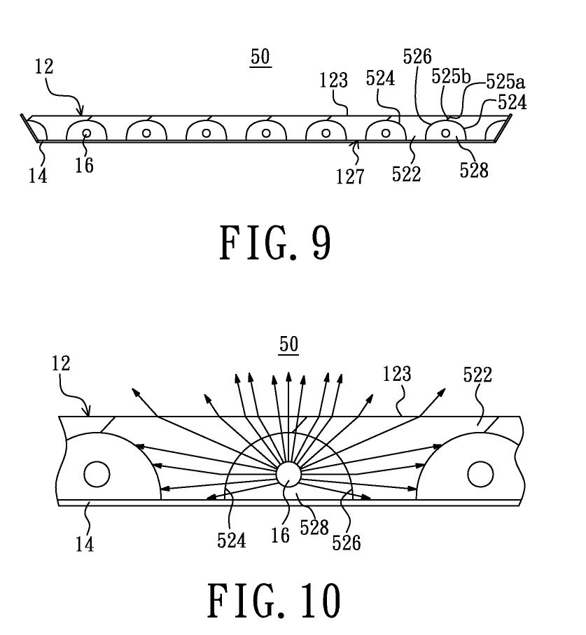

Referring to FIGS. 9 and 10, a direct-type surface light source device 50 in accordance with a fifth embodiment of the present invention is provided. The direct-type surface light source device 50 has a structural configuration similar to that of the direct-type surface light source device 10 in accordance with the first embodiment and includes a light guide plate 12, a reflective plate 14 and a plurality of light sources 16. However, the light guide plate 12 of the direct-type surface light source device 50 includes a plurality of light guide units 522, a first side surface of each of the light guide units 522 includes a first oblique surface 524 and a joint surface 525a, a second side surface of each of the light guide units 522 includes a second oblique surface 526 and a joint surface 525b. The first oblique surface 524 and the second oblique surface 526 are opposite to each other and both adjoining the bottom surface 127. The joint surface 525a is located between and connects the first oblique surface 524 and the light exit surface 123. The joint surface 525b is located between and connects the second oblique surface 526 and the light exit surface 123. The joint surface 525a of one of the each two adjacent light guide units 522 is surface-contacted with the joint surface 525b of the other one. Furthermore, the first oblique surface 524 and the second oblique surface 526 both are curved surfaces, and correspondingly a receiving cavity 528 defined between the each two adjacent light guide units 522 may have a circular cross-section.

Referring to FIG. 10, showing optical paths of the direct-type surface light source device 50. As seen from FIG. 10, light rays emitted from each of the light sources 16 and incident from the two light guide units 522 which are adjacent to the light source 16 to air are, due to the configuration of the first oblique surface 524 and the second oblique surface 526 of the two light guide units 522, primarily directed by the first and second oblique surfaces 524, 526 where a total reflection phenomenon occurs toward the light exit surfaces 123 for output. Furthermore, the curved first and second oblique surfaces 524, 526 render the light rays emitted from each of the light sources 16 and entered into the two light guide units 522 more uniform. Accordingly, the light output uniformity of the direct-type surface light source device 50 is improved.

In addition, it is understood that the receiving cavity 128, 528 defined between the two adjacent light guide units may be changed to have a parabolic cross-section (not shown) or other particular shaped cross-section. The various embodiments of the present invention each allow a plurality of joined light guide units having an identical size to cooperatively form a common light output surface and a plurality of receiving cavities or receiving grooves to receive the light sources therein, which can improve the assembly convenience of the light guide plates when being applied to the direct-type surface light source devices.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light guide plate comprising:
a plurality of light guide units, each of the light guide units comprising a light exit surface, a bottom surface opposite to the light exit surface, a first side surface connecting the light exit surface and the bottom surface and a second side surface opposite to the first side surface, the first side surface comprising a first oblique surface and the second side surface comprising a second oblique surface, the first oblique surface and the second oblique surface opposite to each other and both adjoining the bottom surface,
wherein the first side surface of one of the each two adjacent light guide units is joined with the second side surface of the other one and thereby the light exit surfaces of the light guide units cooperatively form a substantially flat surface, the light guide units defining a plurality of receiving cavities by the first oblique surfaces and the second oblique surfaces thereof, the receiving cavities being spaced apart from one another.

2. The light guide plate as claimed in claim 1, wherein the first side surface of one of the each two adjacent light guide units is joined with the second side surface of the other one by a surface contact manner and whereby one of the receiving cavities is defined.

3. The light guide plate as claimed in claim 2, wherein each of the first side surfaces of the light guide units further comprises a joint surface located between and connecting the first oblique surface and the light exit surface, the joint surface of one of the each two adjacent light guide units is surface-contacted with the second oblique surface of the other one.

4. The light guide plate as claimed in claim 2, wherein each of the first side surfaces of the light guide units further comprises a first joint surface located between and connecting the first oblique surface and the light exit surface, each of the second side surfaces of the light guide units further comprises a second joint surface located between and connecting the second oblique surface and the light exit surface, the first joint surface of one of the each two adjacent light guide units is surface-contacted with the second joint surface of the other one.

5. The light guide plate as claimed in claim 1, wherein the first side surface of one of the each two adjacent light guide units is joined with the second side surface of the other one by a line contact manner and whereby one of the receiving cavities is defined.

6. The light guide plate as claimed in claim 1, wherein each of the receiving cavities has an identical cross-section, and the cross-section is selected from the group consisting of a V-shaped, a circular and a parabolic cross-section.

7. The light guide plate as claimed in claim 1, wherein each of the light guide units has a receiving groove defined in the bottom surface thereof, and the receiving groove extends along a lengthwise direction of the light guide unit and penetrates through the light guide unit.

8. The light guide plate as claimed in claim 7, wherein the receiving groove comprises an arc-shaped groove.

9. The light guide plate as claimed in claim 1, wherein the light guide units have an identical size.

10. A direct-type surface light source device comprising:
a light guide plate comprising a plurality of light guide units, each of the light guide units comprising a light exit surface, a bottom surface opposite to the light exit surface, a first side surface connecting the light exit surface and the bottom surface and a second side surface opposite to the first side surface, the first side surface comprising a first oblique surface and the second side surface comprising a second oblique surface, the first oblique surface and the second oblique surface opposite to each other and both adjoining the bottom surface, wherein the first side surface of one of the each two adjacent light guide units is joined with the second side surface of the other one and thereby the light exit surfaces of the light guide units cooperatively form a substantially flat surface, the light guide units defining a plurality of receiving cavities by the first oblique surfaces and the second oblique surfaces thereof, the receiving cavities being spaced apart from one another;
a reflective plate disposed on the bottom surfaces of the light guide units of the light guide plate; and
a plurality of light sources corresponding to the light guide units of the light guide plate and disposed between the light exit surfaces of the light guide units and the reflective plate, the light sources spaced apart from one another.

11. The direct-type surface light source device as claimed in claim 10, wherein the light sources are respectively disposed in the receiving cavities spaced apart from one another.

12. The direct-type surface light source device as claimed in claim 10, wherein each of the light guide units has a receiving groove defined in the bottom surface thereof, the receiving groove extends along a lengthwise direction of the light guide unit and penetrates through the light guide unit, and the light sources are disposed in the receiving grooves of the light guide units respectively.

13. The direct-type surface light source device as claimed in claim 12, wherein the receiving groove comprises an arc-shaped groove.

14. The direct-type surface light source device as claimed in claim 10, wherein the reflective plate is surface-contacted with the bottom surfaces of the light guide units, the light guide units are disposed on the reflective plate.

15. The direct-type surface light source device as claimed in claim 10, wherein the first side surface of one of the each two adjacent light guide units is joined with the second side surface of the other one by a surface contact manner and whereby one of the receiving cavities is defined.

16. The direct-type surface light source device as claimed in claim 15, wherein each of the first side surfaces of the light guide units further comprises a joint surface located between and connecting the first oblique surface and the light exit surface, the joint surface of one of the each two adjacent light guide units is surface-contacted with the second oblique surface of the other one.

17. The direct-type surface light source device as claimed in claim 15, wherein each of the first side surfaces of the light guide units further comprises a first joint surface located between and connecting the first oblique surface and the light exit surface, each of the second side surfaces of the light guide units further comprises a second joint surface located between and connecting the second oblique surface and the light exit surface, the first joint surface of one of the each two adjacent light guide units is surface-contacted with the second joint surface of the other one.

18. The direct-type surface light source device as claimed in claim 10, wherein the first side surface of one of the each two adjacent light guide units is joined with the second side surface of the other one by a line contact manner and whereby one of the receiving cavities is defined.

19. The direct-type surface light source device as claimed in claim 10, wherein each of the receiving cavities has an identical cross-section, and the cross-section is selected from the group consisting of a V-shaped, a circular and a parabolic cross-section.

20. The direct-type surface light source device as claimed in claim 10, wherein the light guide units have an identical size.
